(19) United States
(12) Patent Application Publication
(10) Pub. No.: US 2003/0067842 A1
(43) Pub. Date: Apr. 10, 2003

(54) Helix streamer acquisition of seismic data

(76) Inventors: Dwight V. Sukup, Sugar Land, TX (US); Paul M. Krail, Bellaire, TX (US)

Correspondence Address: STEPHEN H. CAGLE, HOWREY, SIMON, ARNOLD & WHITE, LLP, 750 BERING DRIVE, HOUSTON, TX, 77057, US

(21) Appl. No.: 09/972,210

(22) Filed: Oct. 5, 2001

(51) Int. Cl. G01V 1/28; G01V 1/00

(52) U.S. Cl. 367/20; 702/14

(57) ABSTRACT

A method for obtaining super source records in a marine application in which a target region is divided into a series of overlapping swaths. Seismic data is then collected for each swath using a fleet of vessels to traverse each swath. The fleet is intended to traverse each swath in a predetermined formation and substantially in unison. Seismic data is collected as each vessel alternates activating its seismic source at predetermined shotpoints along each swath, with reflection data collected by all the receivers after each shot. By careful planning, the proper traversal of numerous overlapping swaths results in a wide array of acquisition data for any given common source position. Super source records are attainable through the processing of this common source position seismic data. These super source records provide wide azimuth seismic data and can be processed to make high-quality seismic images.

### BACKGROUND OF THE INVENTION

The value of seismic surveying to the exploration and discovery of oil and gas formations is well known in the petroleum industry. Developments in computing power have enabled the development and use of seismic surveying including vertical seismic profiling, 3-D seismic surveys, and the monitoring of enhanced recovery operations. In many cases, the processing of the seismic data can be a critical factor in the value of seismic surveying. The final interpretation of a seismic image is only as good as the quality of the processing of the seismic data.

In marine seismic exploration, a seismic survey ship is equipped with an energy source and a receiver for taking seismic profiles of an underwater land configuration. The act of taking profiles is often referred to as “shooting” because explosive devices have been commonly used for many years as energy sources. The energy source is designed to produce compressional waves that propagate through the water and into the underwater land formation. As the compressional waves propagate through the land formation, they strike interfaces between the formations, commonly referred to as “strata,” and reflect back through the earth and water to the receiver. The receiver typically converts the reflected waves into electrical signals which are then processed into an image that provides information about the structure of the subterranean formation.

Presently, one of the most common energy sources for marine seismic surveying is an airgun that discharges air under very high pressure into the water. The discharged air forms a pulse which contains frequencies within the seismic range. The receivers in marine applications are typically referred to as hydrophones. The hydrophones convert pressure waves into electrical signals that are used for analog or digital processing. Most commonly, hydrophones include a piezoelectric element for converting the pressure waves into electrical signals. The hydrophones may be mounted on a long streamer which is towed behind the survey ship at a depth of about 30 ft. In such cases it is not uncommon for the streamer to be several miles long and to carry receivers every few feet in a regularly spaced pattern. Alternatively a string of hydrophones may be substantially vertically suspended in the water at a fixed location. This is referred to as vertical cable marine seismic surveying. Another alternative for marine seismic surveying is bottom cable marine seismic surveying. In bottom cable marine seismic surveying a cable with a fixed array of receivers is deployed on the ocean bottom and a seismic source is towed by a ship and is periodically activated to emit acoustic waves.

As previously mentioned, each time the energy source imparts a seismic pulse into the water, the compressional waves propagate through the land formation, strike strata, and reflect back through the earth and water to the receivers. Each receiver detects the reflected wave, and delivers an electrical signal to a recording device aboard the survey ship. Each recorded signal from a receiver is commonly referred to as a “trace.” Thus, for each seismic pulse generated, many traces may be recorded corresponding to the number of receivers detecting the reflected wave.

Three-dimensional (3-D) pre-stack depth migration has been proven to be a useful processing tool for accurately imaging subsurface formations. This is especially true in areas of complicated geology, such as in areas where high velocity salt bodies may produce shadow zones beneath the salt. Narrow azimuth acquisition may not adequately illuminate the subsalt structures. In seismic data acquisition, azimuth is the angle that the straight line from source to receiver makes with true north, usually measured clockwise. Traditional marine seismic acquisition techniques typically obtain narrow azimuth data because the lines of profile between source and receivers are a narrow range of angles. 3-D imaging techniques have been developed to image wide azimuth shot records, which have a diversity of azimuths of reflection data recorded. One method for processing wide azimuth shot records created from common source or common receiver seismic data is discussed in detail in patent application Ser. No. 09/393,420, which is herein incorporated by reference.

Several methods are available for collecting wide azimuth marine-seismic data. Traditionally, marine 3-D seismic surveys have been recorded using closely spaced parallel lines. However, the drawback to this procedure is the significant nonproductive field time required in changing lines, reshooting lines not recorded correctly, and shooting additional lines to fill in the grid of data necessary for wide azimuth coverage. Several newer techniques have emerged in recent years for improving upon 3-D seismography, including vertical seismic profiling and a data gathering method involving towing a source/receiver streamer along spiral or circular paths. The present invention is intended to provide a superior alternative to these methods.

### SUMMARY OF THE INVENTION

The present invention is generally directed to a method for collecting wide azimuth marine seismic data. More specifically, the present invention utilizes standard marine seismic acquisition equipment to collect seismic data from common source positions at different acquisition geometries. Such seismic data can be processed to produce super source records for each common source position. These super source records provide wide azimuth seismic data and can be processed to make high-quality seismic images.

One embodiment of this invention is a method for obtaining super source records in a marine application. First, a target region is divided into a series of overlapping swaths. Although linear swaths are specifically depicted in the present application, it is intended that the present method is equally applicable to any predetermined course for covering a target region. Next, seismic data is collected for each swath using a fleet of vessels to traverse each swath. Although it is intended that the number and type of vessels may vary depending on preference, economics, and other circumstances, it is a preferred aspect of this embodiment that at least one source vessel and at least one streamer vessel must be a part of the fleet. Each source vessel tows a seismic source and each streamer vessel tows a seismic source and a plurality of streamer cables, with each streamer cable having a plurality of seismic receivers spaced therealong. The fleet is intended to traverse each swath in a predetermined formation and substantially in unison. A preferred aspect of this formation is for a source vessel to navigate between streamer vessels if more than one streamer vessel is deployed so as to avoid the tangling of streamers between streamer vessels. Seismic data is collected as each vessel alternates activating its seismic source at predetermined shotpoints along each swath, with reflection data collected by all the receivers after each shot. By careful planning, the proper traversal of numerous overlapping swaths results in a wide array of acquisition data for any given common source position. Super source records are attainable through the processing of this common source position seismic data.

This and other illustrative embodiments and features of the present invention are more fully set forth in the following description of illustrative embodiments of the invention.

### BRIEF DESCRIPTION OF THE DRAWINGS

The following description is presented with reference to the accompanying drawings in which:

FIG. 1 illustrates the basic acquisition template for a fleet using four vessels.

FIGS. 2A, 2B, 2C, and 2D illustrate the concept of overlapping swaths.

FIG. 3 illustrates the position of the fleet for Swath 1 Shot 1 as described in the Example.

FIG. 4 illustrates the position of the fleet for Swath 1 Shot 2 as described in the Example.

FIG. 5 illustrates the position of the fleet for Swath 1 Shot 3 as described in the Example.

FIG. 6 illustrates the position of the fleet for Swath 1 Shot 4 as described in the Example.

FIG. 7 illustrates the position of the fleet for Swath 2 Shot 1 as described in the Example.

FIG. 8 illustrates the position of the fleet for Swath 2 Shot 2 as described in the Example.

FIG. 9 illustrates the position of the fleet for Swath 2 Shot 3 as described in the Example.

FIG. 10 illustrates the makeup of a super source record that can be assembled from four swaths as described in the Example.

FIGS. 11A and 11B illustrate the difference between the narrow azimuths achievable from traditional seismic acquisition techniques and the wide azimuths achievable according to the methods of the present invention.

FIGS. 12A and 12B illustrate the illumination of a sub-salt formation using traditional seismic acquisition techniques and using the methods of the present invention.

### DESCRIPTION OF ILLUSTRATIVE EMBODIMENTS

One embodiment of this invention is a method for obtaining super source records in a marine application. First, a target region is divided into a series of overlapping swaths. Although linear swaths are depicted in the present application, it is intended that the present method is equally applicable to any predetermined course for covering a target region. Next, seismic data is collected for each swath using a fleet of vessels to traverse each swath. Although it is intended that the number and type of vessels may vary depending on preference, economics, and other circumstances, it is a preferred aspect of this embodiment that at least one source vessel and at least one streamer vessel must be a part of the fleet. Each source vessel tows a seismic source and each streamer vessel tows a seismic source and a plurality of streamer cables, with each streamer cable having a plurality of seismic receivers spaced therealong. The fleet is intended to traverse each swath in a predetermined formation and substantially in unison. A preferred aspect of this formation is with source vessels navigating between streamer vessels if more than one streamer vessel is deployed. Seismic data is collected as each vessel alternates activating its seismic source at predetermined shotpoints along each swath, with reflection data collected by all the receivers after each shot. By careful planning, the proper traversal of numerous overlapping swaths results in a wide array of acquisition data for any given common source position. Super source records are attainable through the processing of this common source position seismic data.

A more detailed illustrative embodiment of the present invention is best presented through the use of an example:

### EXAMPLE

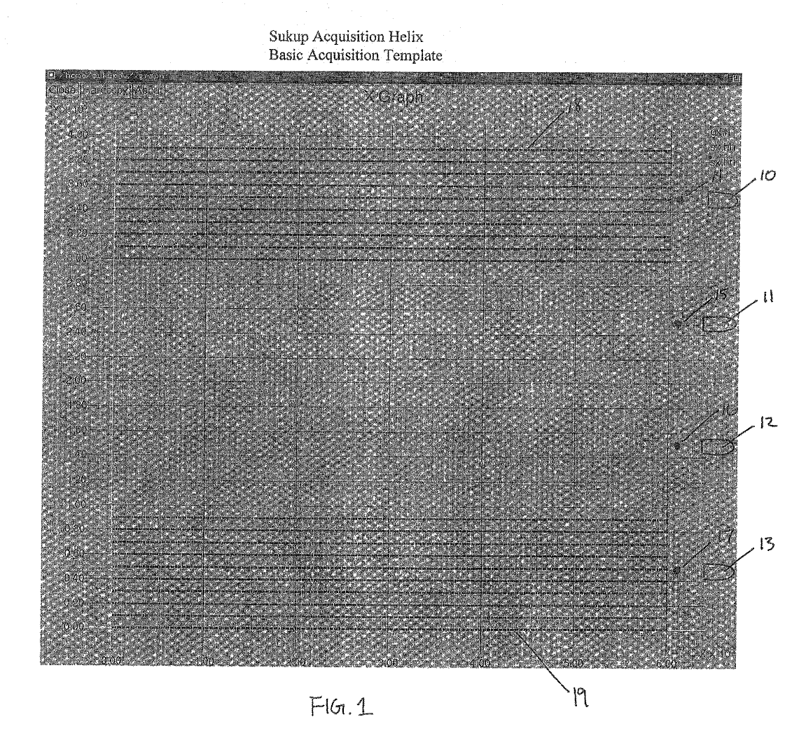

FIG. 1 depicts one embodiment of a four-vessel fleet formation. In this formation, two source vessels 11 and 12 are flanked by two streamer vessels 10 and 13. Each source vessel is configured with a dual (Ping-Pong) source (15 and 16). Each streamer vessel is configured with a dual (Ping-Pong) source (14 and 17) and ten streamers (18 and 19) separated by approximately 100 meters. Each streamer contains 240 hydrophones (not shown) spaced at 25 meter intervals.

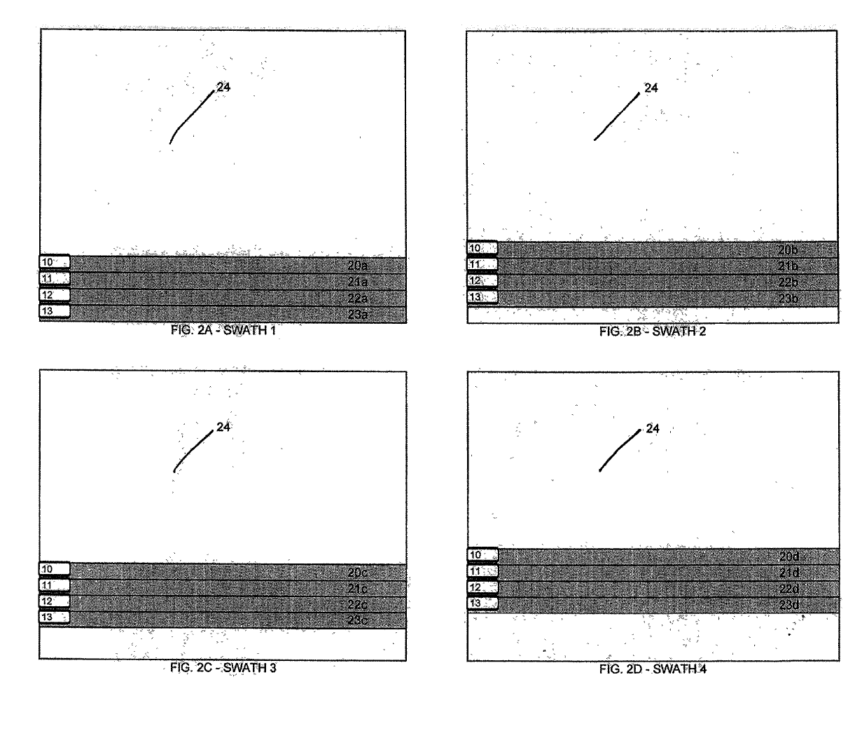

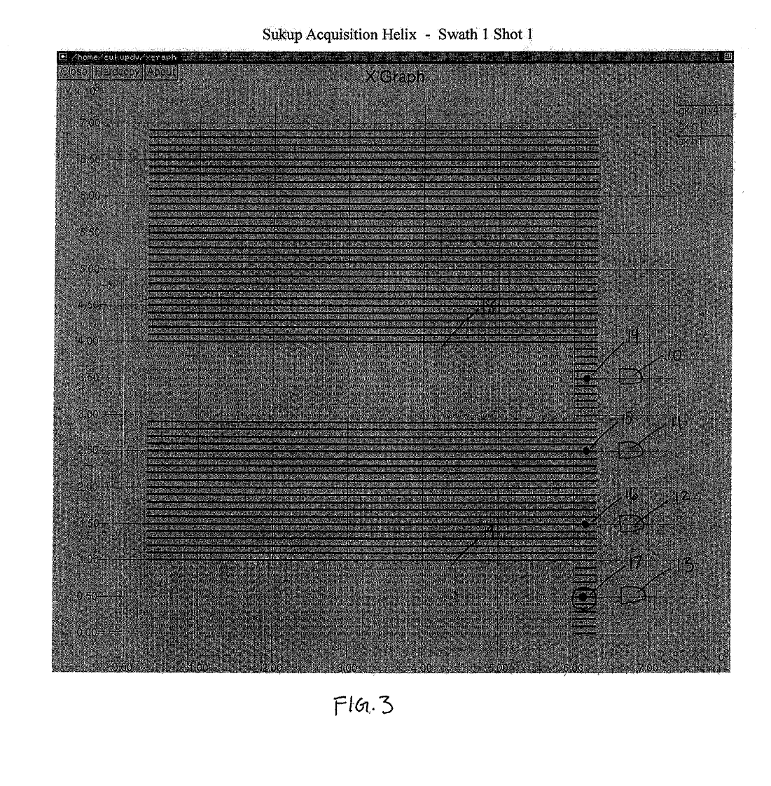

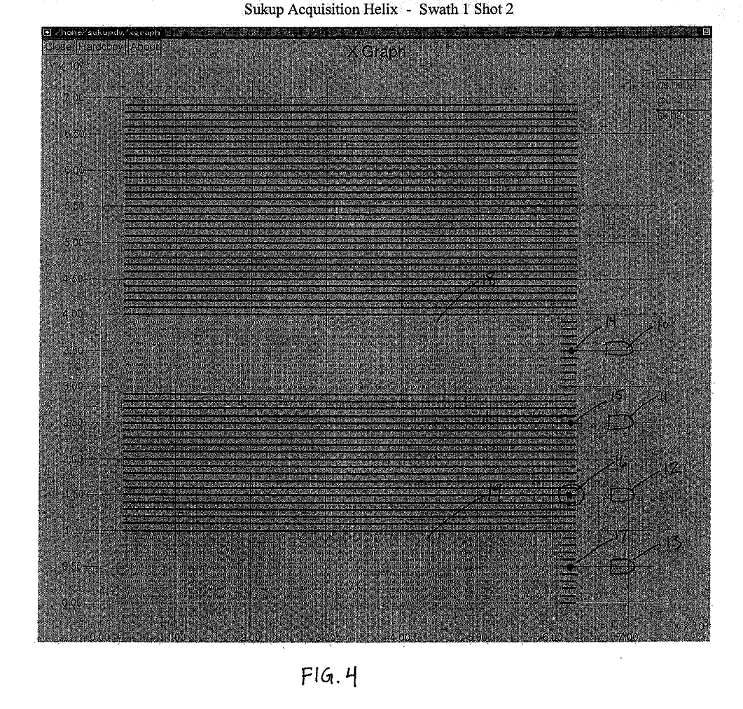

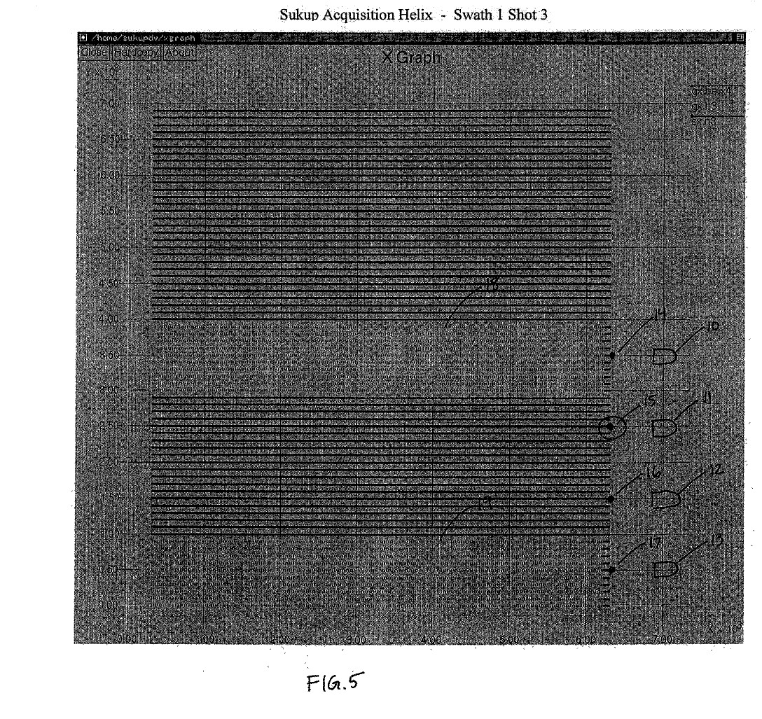

FIG. 2 depicts the concept of overlapping swaths for target region 24. A super source record according to the present invention is attained by collecting wide azimuth seismic data for substantially the same shotpoint source position. By substantially the same shotpoint position, it is meant by the present invention that the source positions for the collected data are close enough to the desired shotpoint position such that adjustments made to the data to centralize the shotpoint position maintain the integrity of the collected data. This can be accomplished by overlapping swaths in such a way so as to have a vessel in a subsequent swath traversing the same path as a vessel from a preceding swath. Although any amount of overlap (one-vessel, two-vessel, three-vessel) is intended by the methods of the present invention, FIGS. 2A-2D illustrate a three-vessel overlap for a four-vessel fleet. In Swath 1 (FIG. 2A), vessels 10, 11, 12, and 13 traverse paths 20a, 21a, 22a, and 23a, respectively, to create Swath 1. In Swath 2 (FIG. 2B), the vessel paths 20b, 21b, 22b, and 23b are shifted by one vessel path such that path 23b is now the same as path 22a from Swath 1. In Swath 3 (FIG. 2C), the vessel paths 20c, 21c, 22c, and 23c are again shifted by one vessel path such that path 23c is now the same as path 21a from Swath 1 and path 22b from Swath 2. In Swath 4 (FIG. 2D), the vessel paths 20d, 21d, 22d, and 23d are again shifted by one vessel path such that path 23d is now the same as path 20a from Swath 1, path 21b from Swath 2, and path 22c from Swath 3. Note that all four vessels have traversed the same path (20a, 21b, 22c, and 23d) by the end of Swath 4, providing a wide array of receiver positions for any common source position along that path.

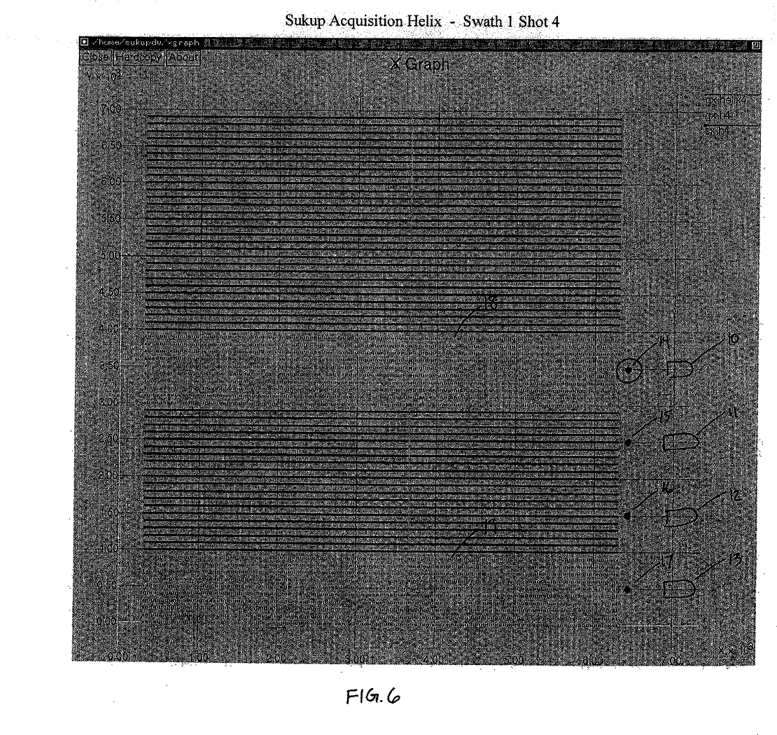

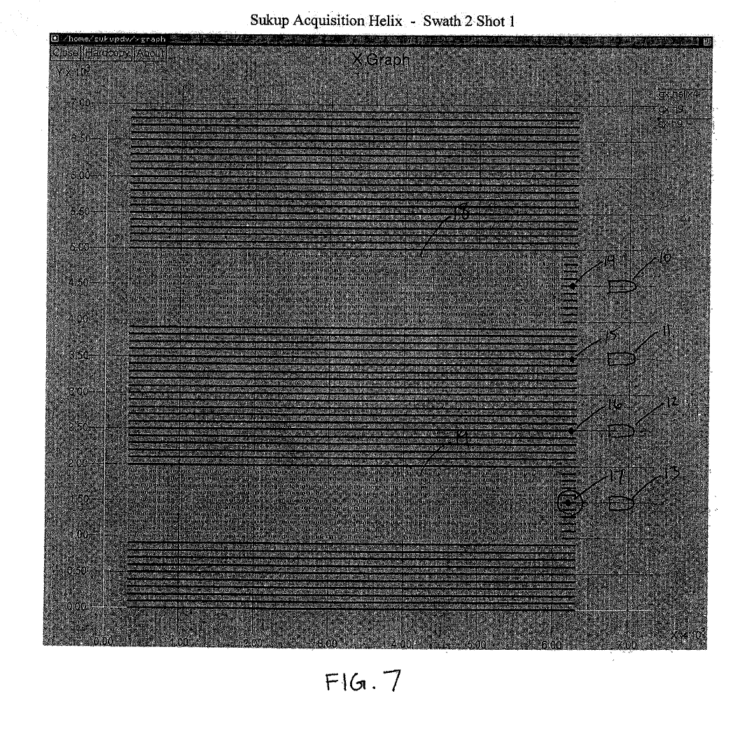

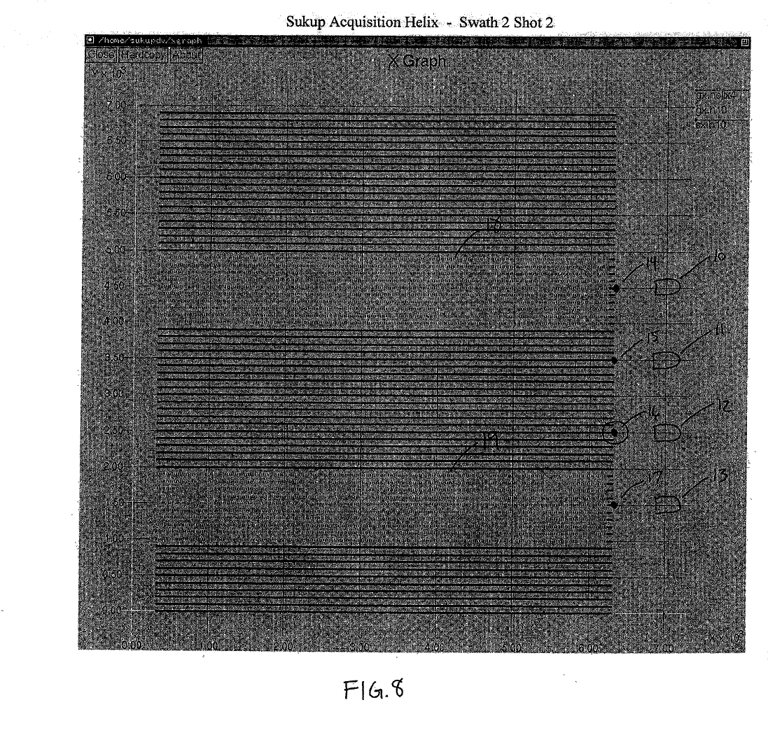

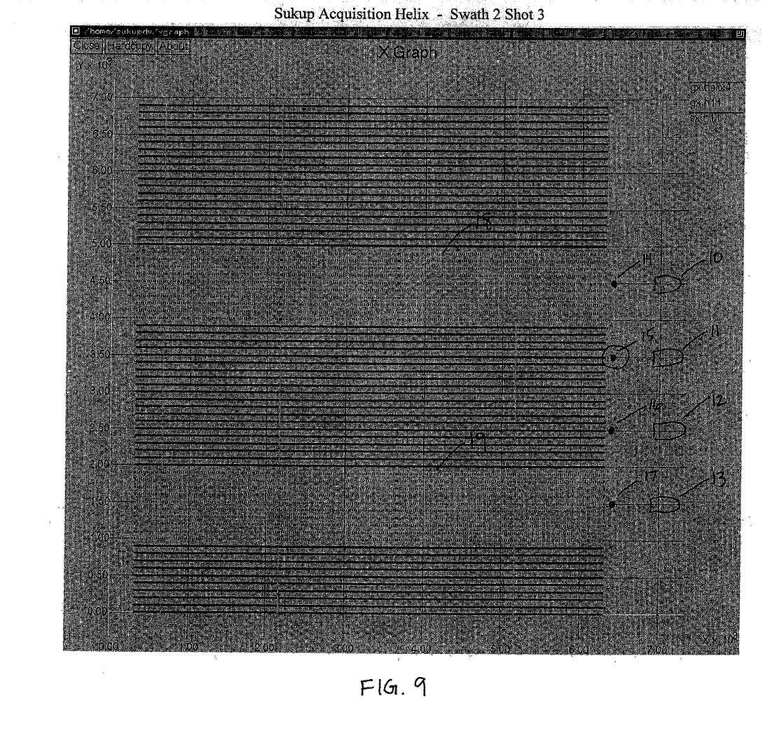

FIGS. 3-9 illustrate the acquisition procedure shot-by-shot that can be used to produce a super source record. In FIG. 3, Swath 1 Shot 1 occurs when streamer vessel fires its dual source 17 at a predetermined position. Streamers 18 and 19 then receive Shot 1 reflection data with the hydrophones. In FIG. 4, Swath 1 Shot 2 occurs when the fleet has advanced 25 meters from where Shot 1 occurred, this interval being called the shotpoint interval. Since each shot is to be alternated amongst the vessels in the fleet, Shot 2 is executed by source vessel 12 firing its dual source 16 at the appropriate shotpoint interval. Streamers 18 and 19 then receive Shot 2 reflection data with the hydrophones. In FIG. 5, Swath 1 Shot 3 is executed by source vessel 11 firing its dual source 15 at the appropriate 25 meter shotpoint interval. Streamers 18 and 19 then receive Shot 3 reflection data with the hydrophones. In FIG. 6, Swath 1 Shot 4 is executed by streamer vessel 10 firing its dual source 14 at the appropriate 25 meter shotpoint interval. Streamers 18 and 19 then receive Shot 4 reflection data with the hydrophones. Shots continue in this manner until Swath 1 is traversed.

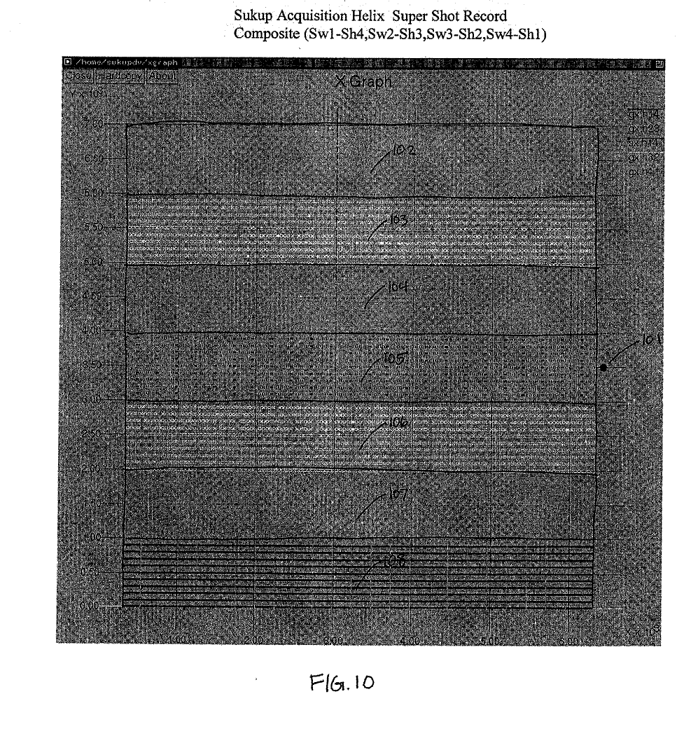

In FIG. 7, Swath 2 Shot 1 is executed by streamer vessel 13 firing its dual source at a position that is displaced one shotpoint interval (25 meters) beyond the position of Swath 1 Shot 1. This displacement allows a super source record to be assembled as is discussed infra. As discussed in FIGS. 2A-2D, Swath 2 is displaced in this Example by one vessel path from Swath 1. Although this Example illustrates a three-vessel overlap, it is intended by the present invention that any amount of overlap is adequate to produce a super source record. Streamers 18 and 19 then receive Shot 1 reflection data with the hydrophones. In FIG. 8, Swath 2 Shot 2 is executed by source vessel 12 firing its dual source 16 at the appropriate 25 meter shotpoint interval. Streamers 18 and 19 then receive Shot 2 reflection data with the hydrophones. In FIG. 9, Swath 2 Shot 3 is executed by source vessel 11 firing its dual source 15 at the appropriate 25 meter shotpoint interval. Streamers 18 and 19 then receive Shot 3 reflection data with the hydrophones. Shots continue in this manner until the target region has been covered for Swath 2. Furthermore, swaths continue in this manner until the entire target region has been covered.

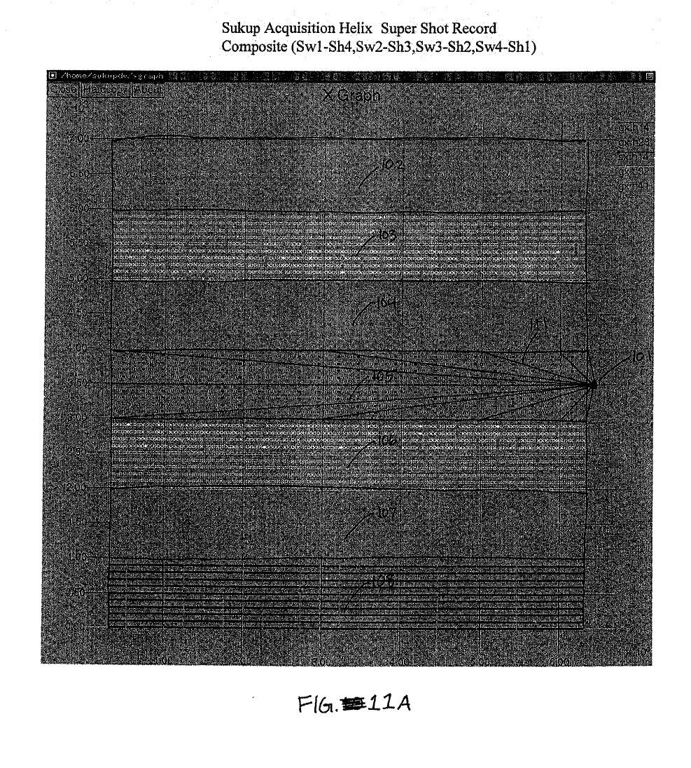

FIG. 10 illustrates how the seismic data acquired can be assembled to produce a super source record. Note that Swath 1 Shot 4 (FIG. 6), Swath 2 Shot 3 (FIG. 9), Swath Shot 2 (not shown), and Swath 4 Shot 1 (not shown) all have the same dual source position 101. The receiver data assembled from these four shots comprise the wide azimuth shot record illustrated in FIG. 10. Seismic data from passes 105 and 108 are collected from Swath 1. Seismic data from passes 104 and 107 are collected from Swath 2. Seismic data from passes 103 and 106 are collected from Swath 3. Seismic data from pass 102 is collected from Swath 4. It is intended by the methods of the present invention that a super source record can be attained by collecting seismic data for substantially the same shotpoint source position. By substantially the same shotpoint source position, it is meant by the present invention that the source positions for the collected data are close enough to the desired shotpoint position such that adjustments made to the data to centralize the shotpoint position maintain the integrity of the collected data.

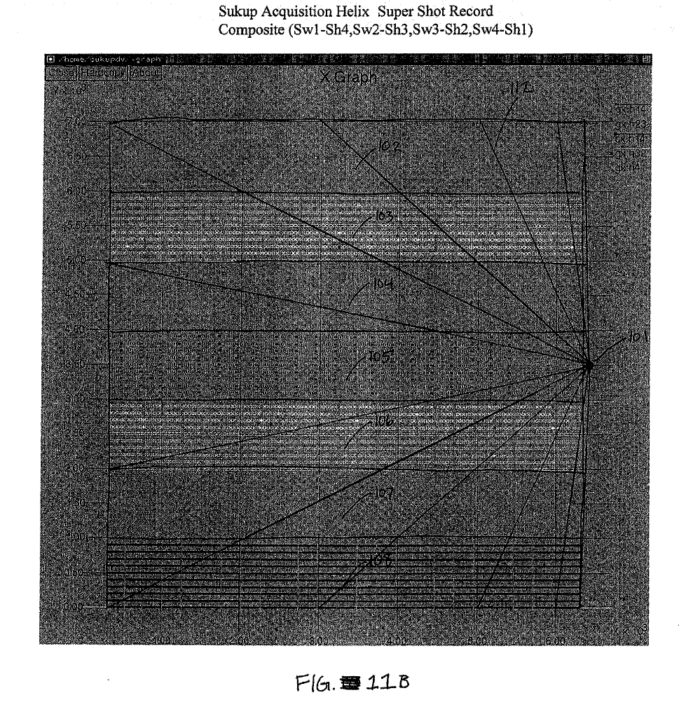

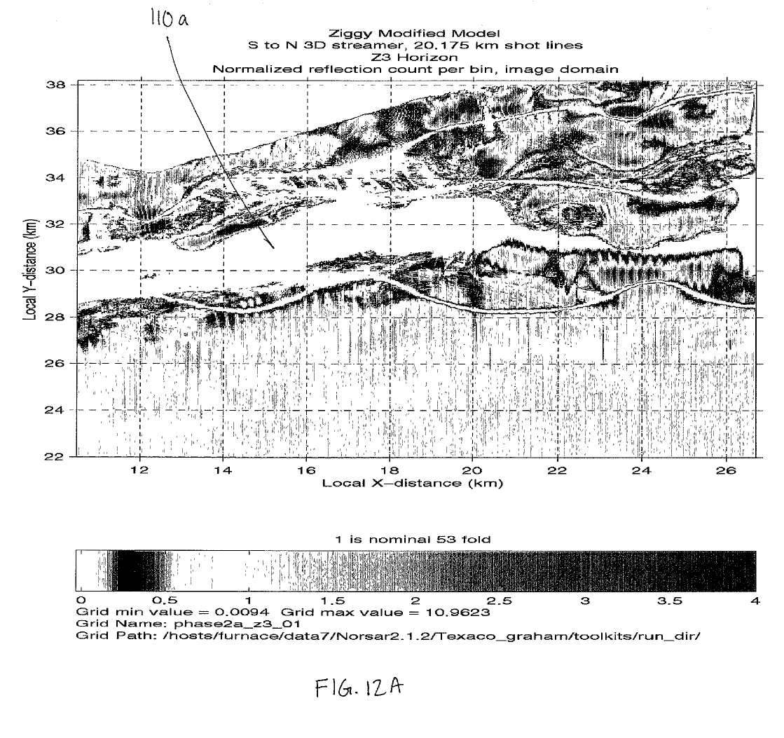

FIGS. 11A and 11B illustrate by example the wide azimuth angles that are achievable with the super source record shown in FIG. 10. FIG. 11A illustrates narrow azimuths 111 that are attainable using only path 105, which is representative of seismic data obtainable through traditional seismic acquisition techniques. FIG. 11B illustrates wide azimuths 112 that are attainable using the methods of the present invention. The extent and angle of the wide azimuths 112 as compared to the narrow azimuths 111 has been found to more evenly illuminate standard subsurface formations, and better illuminate difficult formations such as subsalt structures.

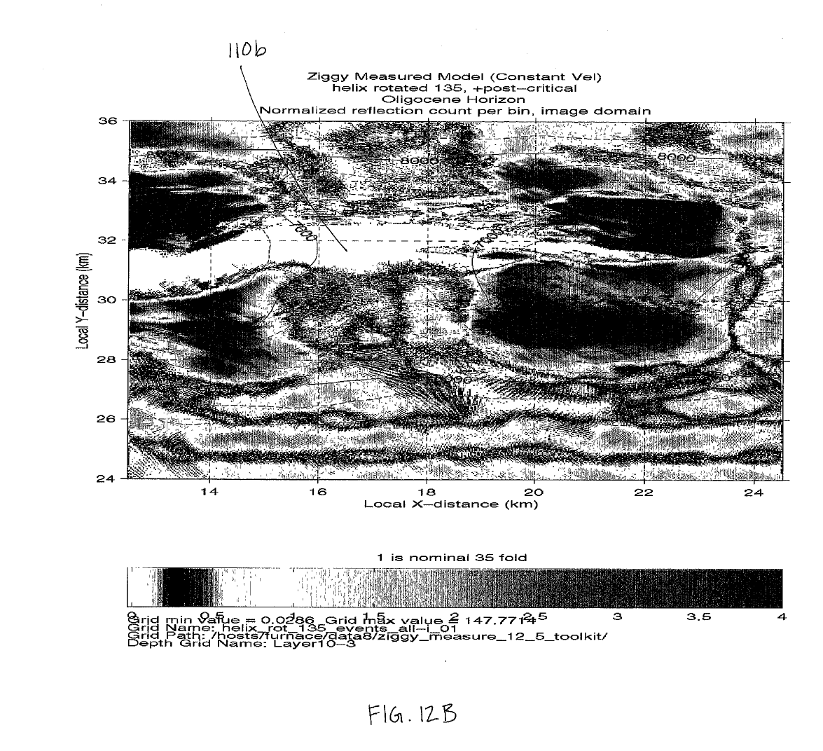

Numerous methods exist for processing the wide azimuth seismic data produced by the methods of the present invention. A preferred method for processing wide azimuth shot records created from common source or common receiver seismic data is discussed in detail in patent application Ser. No. 09/393,420, which is herein incorporated by reference. Three-dimensional (3-D) pre-stack depth migration has also been proven to be a useful processing tool for accurately processing wide azimuth records. This is especially true in areas of complicated geology, such as in area where high velocity salt bodies may produce shadow zones beneath the salt using traditional narrow azimuth imaging. The impact of the present invention can be best understood by comparing illumination maps produced by traditional 3-D seismic acquisition and illumination maps produced by the methods of the present invention. FIG. 12A depicts an illumination map for a sub-salt formation using traditional 3-D seismic acquisition methods. Note the white shadow region 110a that is poor illumination of the sub-salt formation. FIG. 12B depicts an illumination map for the same sub-salt formation using the methods of the present invention. Note the reduction in the shadow region 110b as compared to 110a. The impact of this reduction in shadow region is increased confidence in the seismic imaging of the sub-salt structures.

An alternative embodiment of this invention is a method for making a seismic image using super source records. First, a target region is divided into a series of overlapping swaths. Although linear swaths are depicted in the present application, it is intended that the present method is equally applicable to any predetermined course for covering a target region. Next, seismic data is collected for each swath using a fleet of vessels to traverse each swath. Although it is intended that the number and type of vessels may vary depending on preference, economics, and other circumstances, it is a preferred aspect of this embodiment that at least one source vessel and at least one streamer vessel must be a part of the fleet. Each source vessel tows a seismic source and each streamer vessel tows a seismic source and a plurality of streamer cables, with each streamer cable having a plurality of seismic receivers spaced therealong. The fleet is intended to traverse each swath in a predetermined formation and substantially in unison. A preferred aspect of this formation is with source vessels navigating between streamer vessels if more than one streamer vessel is deployed. Seismic data is collected as each vessel alternates activating its seismic source at predetermined shotpoints along each swath, with reflection data collected by all the receivers after each shot. By careful planning, the proper traversal of numerous overlapping swaths results in a wide array of acquisition data for any given common source position. Super source records are attainable through the processing of this common source position seismic data. Super source records can then be processed using seismic data processing techniques to make a seismic image.

While the present invention has been described in terms of preferred embodiments and examples, it should be apparent to those of skill in the art that variations may be applied to what has been described herein without departing from the concept and scope of the invention. All such similar substitutes and modifications apparent to those skilled in the art are deemed to be within the scope and concept of the invention as it is set out in the following claims.

What is claimed is:

1. A method for creating super source records, comprising the steps of:
(a) Dividing a target region into a series of swaths, wherein each subsequent swath overlaps each preceding swath;
(b) Collecting seismic data for each swath; and
(c) Compiling super source records from the seismic data.

2. The method according to claim 1, wherein the collecting step comprises deploying a fleet of vessels.

3. The method according to claim 2, wherein the fleet comprises at least one source vessel and at least one streamer vessel.

4. The method according to claim 3, wherein each source vessel tows a seismic source and each streamer vessel tows a seismic source and a plurality of streamer cables, each streamer cable having a plurality of seismic receivers spaced therealong.

5. The method according to claim 4, wherein the fleet navigates each swath in a predetermined formation substantially in unison.

6. The method according to claim 1, wherein the collecting step comprises activating a seismic source from the fleet at predetermined shotpoints along each swath, wherein the seismic source activated at each shotpoint is alternated.

7. The method according to claim 6, wherein the collecting step comprises receiving reflection data with the plurality of seismic receivers, wherein the reflection data includes common source position seismic data.

8. The method according to claim 1, wherein the compiling step comprises processing common source position seismic data to create super shot records.

9. A method for creating super source records, comprising the steps of:
(a) Dividing a target region into a series of swaths, wherein each subsequent swath overlaps each preceding swath;
(b) Collecting seismic data for each swath by deploying a fleet of vessels, the fleet comprising two source vessels and two streamer vessels; and
(c) Compiling super source records from the seismic data.

10. The method according to claim 9, wherein the two source vessels each tows a seismic source and the two streamer vessels each tows a seismic source and at least one streamer cable, each streamer cable having a plurality of seismic receivers spaced therealong.

11. The method according to claim 10, wherein the two source vessels navigate between the two streamer vessels along each swath substantially in unison.

12. The method according to claim 9, wherein the collecting step comprises activating a seismic source from the fleet at predetermined shotpoints along each swath, wherein the seismic source activated at each shotpoint is alternated.

13. The method according to claim 12, wherein the collecting step comprises receiving reflection data with the plurality of seismic receivers, wherein the reflection data includes common source position seismic data.

14. The method according to claim 9, wherein the compiling step comprises processing common source position seismic data to create super shot records.

15. A method for making a seismic image using super source records, comprising the steps of:
(a) Dividing a target region into a series of swaths, wherein each subsequent swath overlaps each preceding swath;
(b) Collecting seismic data for each swath;
(c) Compiling super source records from the seismic data; and
(d) Processing the super source records to make a seismic image.

16. The method according to claim 15, wherein the collecting step comprises deploying a fleet of vessels.

17. The method according to claim 16, wherein the fleet comprises at least one source vessel and at least one streamer vessel.

18. The method according to claim 17, wherein each source vessel tows a seismic source and each streamer vessel tows a seismic source and a plurality of streamer cables, each streamer cable having a plurality of seismic receivers spaced therealong.

19. The method according to claim 18, wherein the fleet navigates each swath in a predetermined formation substantially in unison.

20. The method according to claim 15, wherein the collecting step comprises activating a seismic source from the fleet at predetermined shotpoints along each swath, wherein the seismic source activated at each shotpoint is alternated.

21. The method according to claim 20, wherein the collecting step comprises receiving reflection data with the plurality of seismic receivers, wherein the reflection data includes common source position seismic data.

22. The method according to claim 15, wherein the compiling step comprises processing common source position seismic data to create super shot records.

23. The method according to claim 15, wherein the processing step comprises three-dimensional pre-stack depth migration.

24. A method for making a seismic image using super source records, comprising the steps of:
(a) Dividing a target region into a series of swaths, wherein each subsequent swath overlaps each preceding swath;
(b) Collecting seismic data for each swath by deploying a fleet of vessels, the fleet comprising two source vessels and two streamer vessels;
(c) Compiling super source records from the seismic data; and
(d) Processing the super source records to make a seismic image.

25. The method according to claim 24, wherein the two source vessels each tows a seismic source and the two streamer vessels each tows a seismic source and at least one streamer cable, each streamer cable having a plurality of seismic receivers spaced therealong.

26. The method according to claim 25, wherein the two source vessels navigate between the two streamer vessels along each swath substantially in unison.

27. The method according to claim 24, wherein the collecting step comprises activating a seismic source from the fleet at predetermined shotpoints along each swath, wherein the seismic source activated at each shotpoint is alternated.

28. The method according to claim 27, wherein the collecting step comprises receiving reflection data with the plurality of seismic receivers, wherein the reflection data includes common source position seismic data.

29. The method according to claim 24, wherein the compiling step comprises processing common source position seismic data to create the super shot records.

30. The method according to claim 24, wherein the processing step comprises three-dimensional pre-stack depth migration.
